(19) United States
(12) Patent Application Publication
(10) Pub. No.: US 2014/0133822 A1
(43) Pub. Date: May 15, 2014

(54) ROTATABLE FURCATION ASSEMBLY

(71) Applicants: Cesar Alejandro de los Santos Campos, Reynosa (MX); Terry Lee Cooke, Hickory, NC (US); Christopher Shawn Houser, Newton, NC (US); Sean Christopher Kelly, Hickory, NC (US); Jose Manuel Hernandez Quintana, Reynosa (MX)

(72) Inventors: Cesar Alejandro de los Santos Campos, Reynosa (MX); Terry Lee Cooke, Hickory, NC (US); Christopher Shawn Houser, Newton, NC (US); Sean Christopher Kelly, Hickory, NC (US); Jose Manuel Hernandez Quintana, Reynosa (MX)

(21) Appl. No.: 13/675,114

(22) Filed: Nov. 13, 2012

(51) Int. Cl. G02B 6/36

(52) U.S. Cl. CPC G02B 6/3616
USPC 385/137

(57) ABSTRACT

A rotatable furcation assembly for furcating optical fibers of a multi-fiber fiber-optic cable to form multiple connecting cables is disclosed. The furcation assembly includes a furcation plug having a central, longitudinal axis and an interior sized to accommodate the furcation of the optical fibers. The furcation assembly also has a clip member with a holding feature and at least one mounting feature. The holding feature has a truncated tubular body that holds the furcation plug such that the furcation plug can axially rotate.

### FIELD

The present disclosure relates generally to fiber-optic cables and connectors, and in particular relates to a rotatable furcation assembly used to furcate fiber-optic cables.

### BACKGROUND

Fiber-optic cables are the backbone of fiber-optic communication systems. Fiber-optic cables carry optical fibers and other cable elements, which are protected from the external environment by an external jacketing. The optical fibers may be surrounded by strength members and protective elements and may be loosely disposed within tubes (“buffer tubes”).

In certain applications, the optical fibers carried in the multi-fiber fiber-optic cable (“MF cable”) need to be extracted and used to form single-fiber or dual-fiber cables (“connecting cables”), which are then routed and connected to telecommunications equipment, such as a fiber-optic module. This process is referred to in the art as “furcation.”

To facilitate the furcation process, a furcation assembly is typically used to organize and protect the optical fibers extracted from the MF cable while also allowing individual optical fibers to be easily handled, connectorized and spliced. The furcation assembly also prevents degradation of the prepared fibers and protects the fiber ends from moisture, dust and other contaminants. An example of a conventional furcation assembly is disclosed in U.S. Pat. No. 7,903,925, which is incorporated by reference herein.

Conventional furcation assemblies have limited functionality especially as it relates to moving and orienting a mounted furcation assembly. This makes routing MF cables and connecting cables unduly complex and inefficient. In particular, it typically requires twisting the MF cables and connecting cables to achieve the proper cable orientations, which adds to installation difficulty and time, and places unnecessary strain on the cables. In addition, conventional furcation assemblies are designed for a specific type of MF cable and connecting cable and so cannot readily accommodate different MF and connecting cables.

### SUMMARY

An aspect of the disclosure is a furcation assembly for furcating optical fibers of a multi-fiber fiber-optic cable (“MF cable”) to form multiple connecting cables. The assembly includes a furcation plug having a central, longitudinal axis and an interior sized to accommodate furcation of the optical fibers. The assembly also includes a clip member having at least one mounting feature and having a holding feature that holds the furcation plug such that the furcation plug can axially rotate within the holding feature.

Another aspect of the disclosure is a telecommunications apparatus that includes an equipment rack, a housing supported by the equipment rack and configured to operably support one or more telecommunication devices, and a mounting structure having one or more second mounting features and that is mounted to either the equipment rack or the housing. The apparatus also includes the furcation assembly as described above and which is operably mounted to the mounting structure. The MF cable and connecting cables are furcated within the furcation plug interior. The connecting cables are operably connected to the one or more telecommunication devices.

Another aspect of the disclosure is a furcation assembly for furcating optical fibers from a MF cable to form multiple connecting cables. The assembly includes a furcation plug having a central, longitudinal axis, an interior sized to accommodate furcation of the optical fibers section, and a front end configured to engage a removable front cover having apertures sized to pass one or more of the connecting cables. The assembly also includes a cylindrical clip member having a holding feature with a second central, longitudinal axis and that is configured such that the furcation plug can be snap-engaged with the holding feature so that the first and second central axes are substantially coaxial. The furcation plug can axially rotate within the holding feature, and the cylindrical clip member includes at least one mounting feature.

Another aspect of the disclosure is telecommunications apparatus that includes the furcation assembly as described immediately above, an equipment rack, and a housing supported by the equipment rack and configured to operably support one or more telecommunication devices. The apparatus also includes a mounting structure having one or more second mounting features and that is mounted to either the equipment rack or the housing. The clip member of the furcation assembly is mounted to the mounting plate, with an MF cable and connecting cables furcated within the furcation plug interior, and the connecting cables having ends configured to operably connected to the one or more telecommunications devices.

Another aspect of the disclosure is a method of furcating optical fibers in a multi-fiber fiber-optic cable (“MF cable”) to form connecting cables. The method includes furcating the MF cable optical fibers within an interior of a furcation plug having a longitudinal axis. The method also includes holding the furcation plug in a holding feature of a clip member, wherein the furcation plug can axially rotate within the holding feature.

Additional features and advantages of the invention are set forth in the Detailed Description that follows, and in part will be readily apparent to those skilled in the art from that description or recognized by practicing the invention as described herein, including the Detailed Description that follows, the claims and the appended drawings.

The accompanying drawings are included to provide a further understanding of the invention and are incorporated into and constitute a part of this specification. The drawings illustrate various embodiments of the invention and, together with the detailed description, serve to explain the principles and operations thereof

### BRIEF DESCRIPTION OF THE DRAWINGS

These and other features, aspects and advantages of the present invention are better understood when the following detailed description of the invention is read with reference to the accompanying drawings, in which:

FIGS. 1 and 2 are elevated and partially exploded views, and

FIG. 3 is an elevated view of an example furcation assembly according to the disclosure;

FIG. 4 is an elevated bottom-up view of the clip member of the furcation assembly;

FIG. 5 is an elevated view of the furcation plug of the furcation assembly;

FIG. 6A is an elevated view of an example clip member and mounting plate according to one example embodiment;

FIG. 6B is the furcation assembly formed by the furcation plug and the clip member of FIG. 6A;

FIGS. 6C and 6D are similar to FIG. 6A and 6B and illustrate an example clip member and furcation assembly that includes guide arms at the front end of the clip member;

FIG. 7A is an elevated view of an example clip member and mounting plate according to another example embodiment;

FIG. 7B is the furcation assembly formed by the furcation plug and the clip member of FIG. 7A;

FIGS. 8A through 8C are elevated rear-end views of an example equipment rack that supports a fiber-optic equipment housing, and showing the furcation assembly being used to route connecting cables to the equipment housing;

FIG. 8D is similar to FIG. 8A and illustrates an example embodiment wherein the connecting cables are connectorized and routed to ports of an example telecommunications device housed within the equipment housing;

FIG. 9A is an elevated view and FIG. 9B is a close-up elevated view of a first example housing that houses a plurality of furcation assemblies; and

FIG. 10A is an elevated view and FIG. 10B is a close-up elevated view of a second example housing that houses a plurality of furcation assemblies.

### DETAILED DESCRIPTION

Reference is now made to embodiments of the invention, examples of which are illustrated in the accompanying drawings. Whenever possible, the same or similar reference numbers and symbols are used throughout the drawings to refer to the same or similar parts. Cartesian coordinates are shown in some of the Figures and are provided by way of reference and to facilitate the description, and are not intended as being limiting as to direction and orientation.

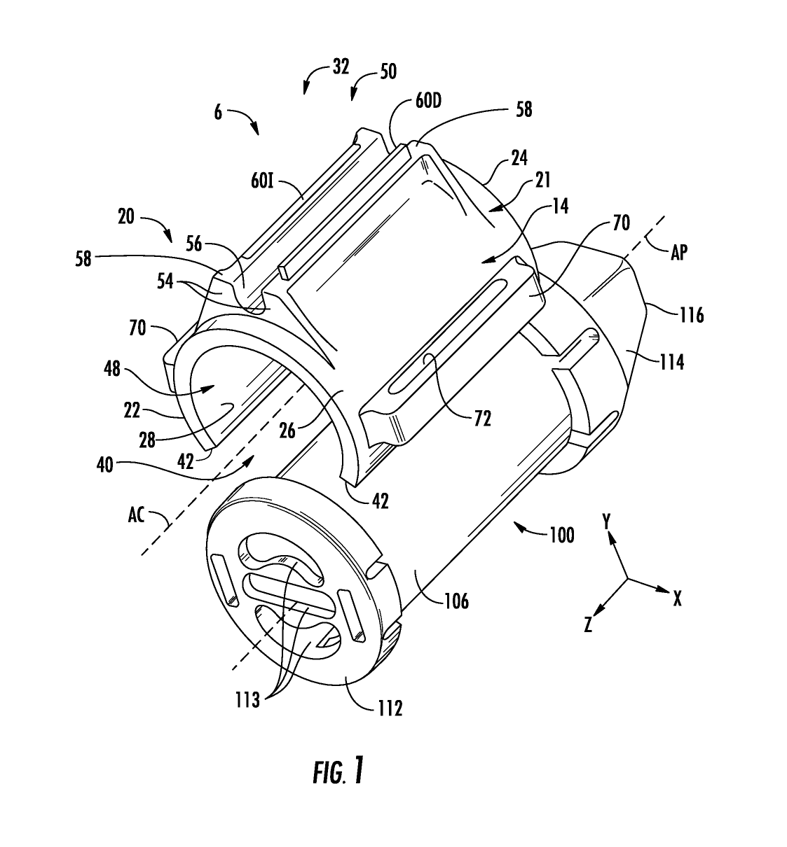

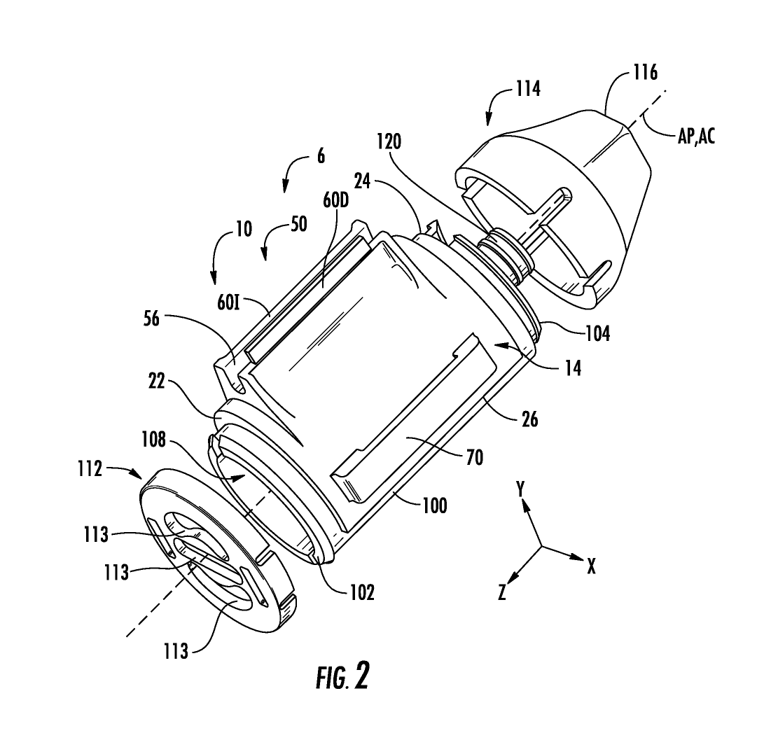

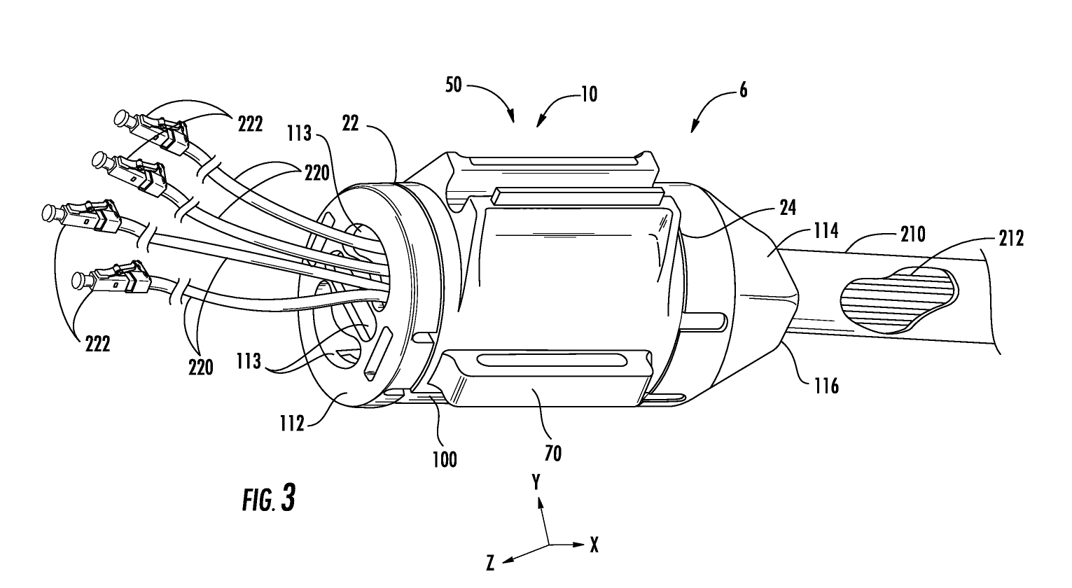

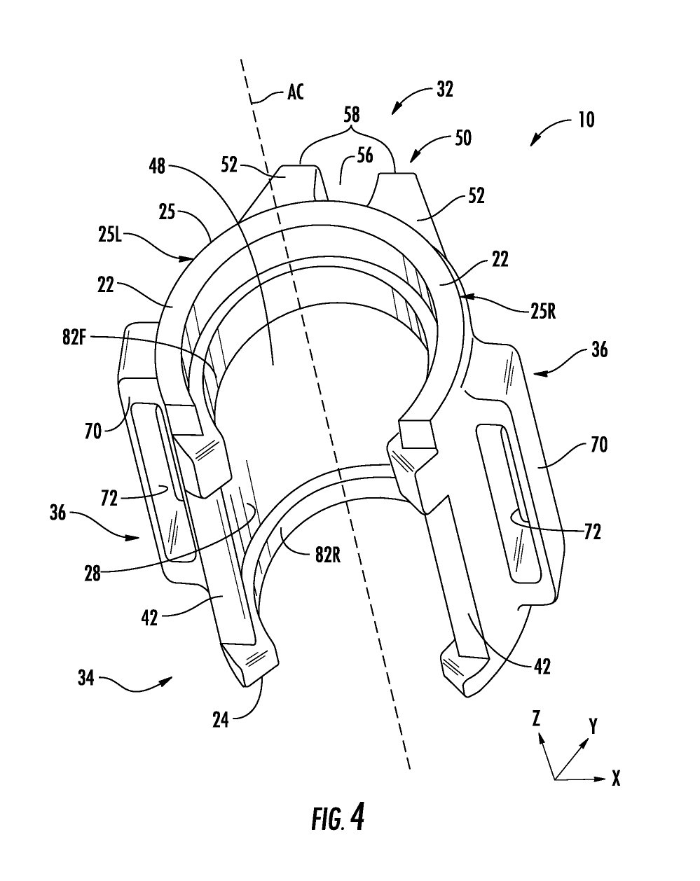

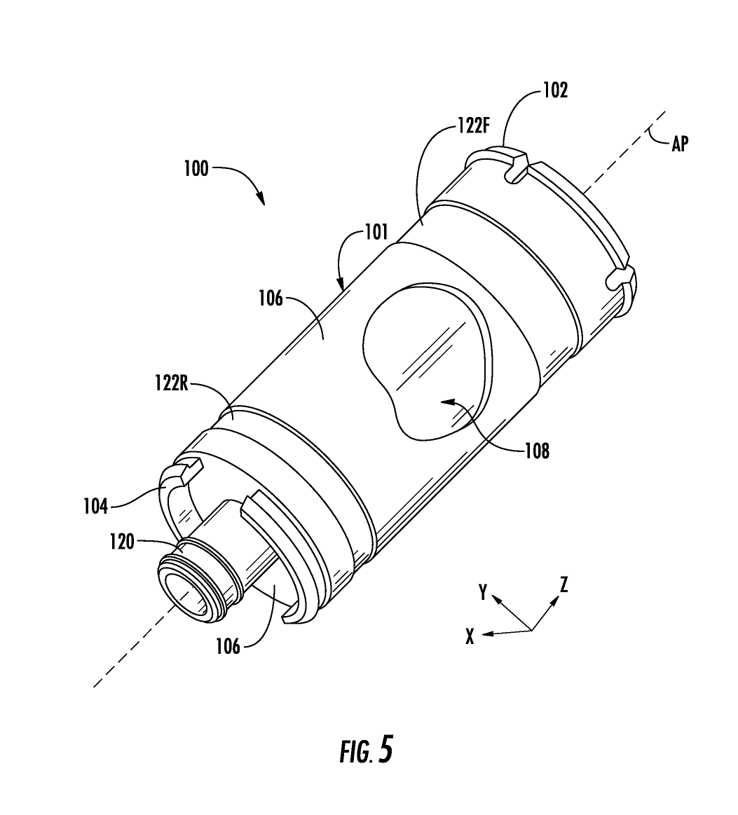

FIGS. 1 and 2 are elevated and partially exploded views, and FIGS. 3 and 4 are elevated views of an example rotatable furcation assembly 6 according to the disclosure. The furcation assembly 6 includes a clip member 10, a close-up view of which is shown in FIG. 4, and a furcation plug 100, a close-up view of which is shown in FIG. 5. The clip member 10 includes a holding feature 14 having a central, longitudinal axis AC, while furcation plug 100 includes a central, longitudinal axis AP.

With reference in particular to FIG. 1 and FIG. 4, clip member 10 is defined by a generally hollow tubular body 20 comprising a curved wall 25 that in part defines the holding feature 14. In the exemplary embodiment, the tubular body can be a partial tubular cylinder with a generally circular cross section. The wall 25 is truncated in an X-Z plane below axis AC such that its cross-section has a horseshoe-like shape. The clip member 10 includes open front and rear ends 22 and 24, an outer surface 26 and an inner surface 28. The clip member 10 also has top and bottom sides 32 and 34, and lateral sides 36. The bottom side 34 includes a longitudinal opening 40 defined by the truncation of wall 25. The longitudinal opening 40 defines left and right wall sections 25L and 25R of wall 25.

The opening 40, along with inner surface 28 and open front and rear ends 22 and 24, defines an open cavity 48. The opening 40 defines edges 42L and 42R of left and right wall sections 25L and 25R, wherein the edges are generally parallel to the X-Z plane. The opening 40 allows left and right wall sections 25L and 25R to outwardly flex when a spreading force is applied and to snap back into position when the spreading force is removed. The flexible left and right wall sections 25L and 25R constitute an example holding feature 14.

Example materials for clip member 10 include metal, plastic, ULTEM®, LEXAN®, VALOX®, nylon and the like.

The clip member 10 includes at least one mounting feature 50 at top side 32. In an example, mounting feature 50 is defined by a longitudinally extending raised portion 52 having longitudinally running ledges 54 with a longitudinal groove 56 therebetween. The ledges 54 include respective top surfaces 58, with one of the top surfaces including a longitudinal detent 60D and the other top surface including a longitudinal indent 60I. This type of mounting feature allows for clip members 10 to be mounted to each other.

The clip member 10 also includes at least one securing feature 70 on outer surface 26. In an example, two longitudinally extending securing features 70 are provided on outer surface 26 at respective lateral sides 36 of left and right wall sections 25L and 25R, with the securing features having a slot 72 sized to accommodate a securing element such as a strap (not shown).

The clip member 10 also includes on inner surface 28 adjacent front and rear ends 22 and 24 front and rear retaining features 82F and 82R, whose purpose is explained below. The front and rear retaining features 82F and 82R are shown by way of example as retaining rings that protrude from inner surface 28.

With continuing reference to FIGS. 1 through 6, an example furcation plug 100 has a generally cylindrical, tubular hollow body 101 with a circular cross-section. The furcation plug 100 has a front end 102 and a rear end 104, and an outer surface 106 and an interior 108. The interior 108 is sized to accommodate the furcation of multiple optical fibers 212 of an MF cable 210.

The front end 102 is configured to receive and engage an end cap 112, while rear end 104 is configured to receive and engage a strain-relief member (boot) 114. The configuration of front and rear ends 102 and 104 can be any one of the many different types of engaging configurations, such as a threaded fitting, a snap-on fitting, a clip-on fitting, a twist-on fitting, a flange-based fitting, etc.

The interior 108 is sized to accommodate the furcation of multiple optical fibers 212 of MF cable 210 to form single-fiber, dual-fiber or other multiple-fiber connecting cables 220, as shown in FIG. 3. The connecting cables 220 are also referred to in the art as “legs.” In an example, connecting cables 220 have respective connectorized ends 222, as shown in FIG. 3. Example connectorized ends 22 include a connector, a pigtail configured for splicing, or a field-installable connector.

The end cap 112 of furcation plug 100 includes at least one aperture 113 sized to pass connecting cables 220. In an example, end cap 112 includes multiple apertures 113 wherein each aperture can pass multiple connecting cables 220. In the example shown, end cap 112 includes a central aperture 113 along with kidney-shaped (i.e., arcuate) apertures above and below. The rear end 104 includes an end wall 107 from which protrudes a guide tube 120. The strain-relief member 114 covers guide tube 120 and has an open back end 116. The central guide tube 120 is sized to pass multiple optical fibers 212 from MF cable 210.

The MF cable 210 can be any type of multi-fiber cable, such as a trunk cable, a distribution cable or a harness cable used in optical telecommunications systems and networks. In an example, MF cable 210 includes optical fibers 212 in multiples of 12, for a total of up to 144 optical fibers. In an example, optical fibers 212 are packed in sub-groups of optical fibers for ease of furcation into multiple connecting cables 220.

The outer surface 106 of furcation plug body 101 includes at least one retaining feature 122. In the example shown in FIG. 5, furcation plug body 101 includes front and rear retaining features 122F and 122R, which by way of example are shown in FIG. 5 as indented rings. The front and rear retaining features 122F and 122R of furcation plug body 101 are configured to be complementary to front and rear retaining features 82F and 82R of clip member 10.

The clip member 10 is thus configured so furcation plug 100 can be clipped into and held by holding feature 14 while also being allowed to axially rotate within the holding feature. In an example, longitudinal axis AC of holding feature 14 is substantially coaxial with longitudinal axis AP of furcation plug 100 when the furcation plug is held by the holding feature.

The furcation plug 100 is inserted into holding feature 14 by urging the furcation plug into opening 40, which gives rise to a spreading force that causes wall sections 25L and 25R to outwardly flex. This causes opening 40 to increase in size so that furcation plug 100 enters open cavity 48 and then is held therein when wall sections 25L and 25R flex back to their original positions. Thus, furcation plug 100 is snap fitted into open cavity 48 of holding feature 14.

The front and rear retaining features 82F and 82R of clip member 10 operably engage front and rear retaining features 122F and 122R of furcation plug 100, thereby further retaining the furcation plug within clip member cavity 48, and in particular limiting the axial movement of the furcation plug relative to the clip member. In an example, clip member retaining features 82F and 82R and furcation plug retaining features 122F and 122R serve to set and maintain axial alignment between the clip member and the furcation plug while also allowing for axial rotation of the furcation plug.

In an example clip member 10 is sized so that it does not interfere with the adding and removing of removable end cap 112 and removable strain-relief member 114 from respective front and rear ends 102 and 104 of furcation plug 100.

When clip member 10 is mounted to a mounting structure 200 such as a mounting plate as shown and discussed below, furcation plug 100 can be rotated within holding feature 14 while the clip member remains stationary. This allows for MF cable 210 and connector cables 220 to be more readily routed to and from furcation assembly 6. In particular, it allows for furcation plug 100 to be rotated to accommodate the orientation of optical fibers 212 in MF cable 210 rather than having to twist the MF cable to fit the orientation of the furcation plug.

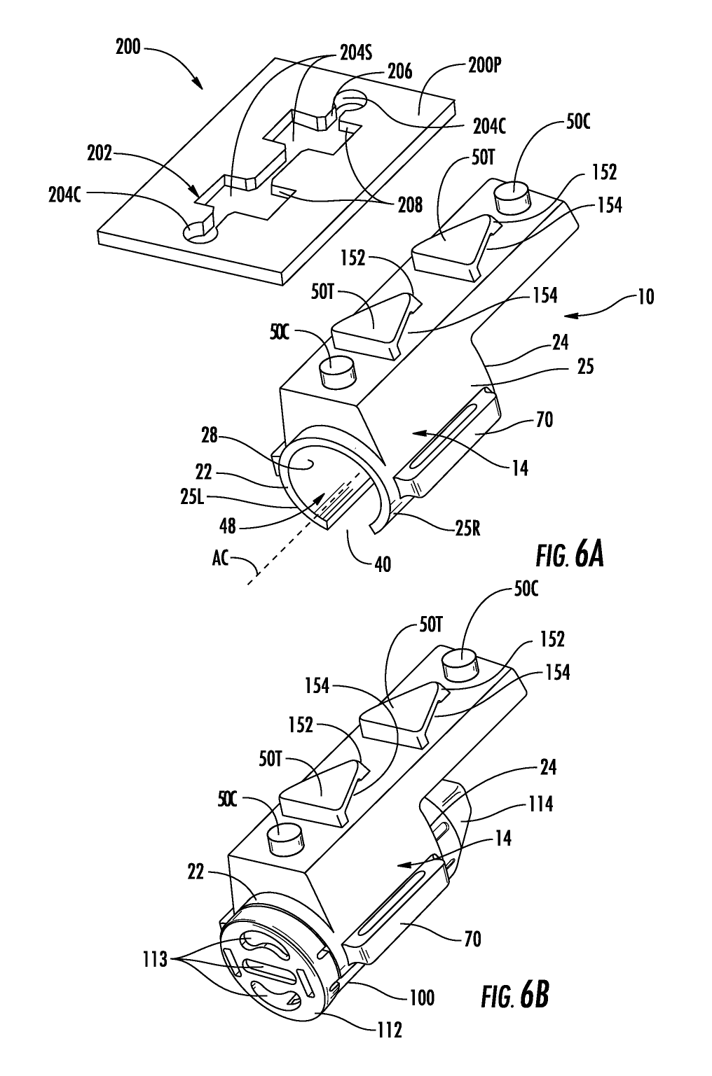

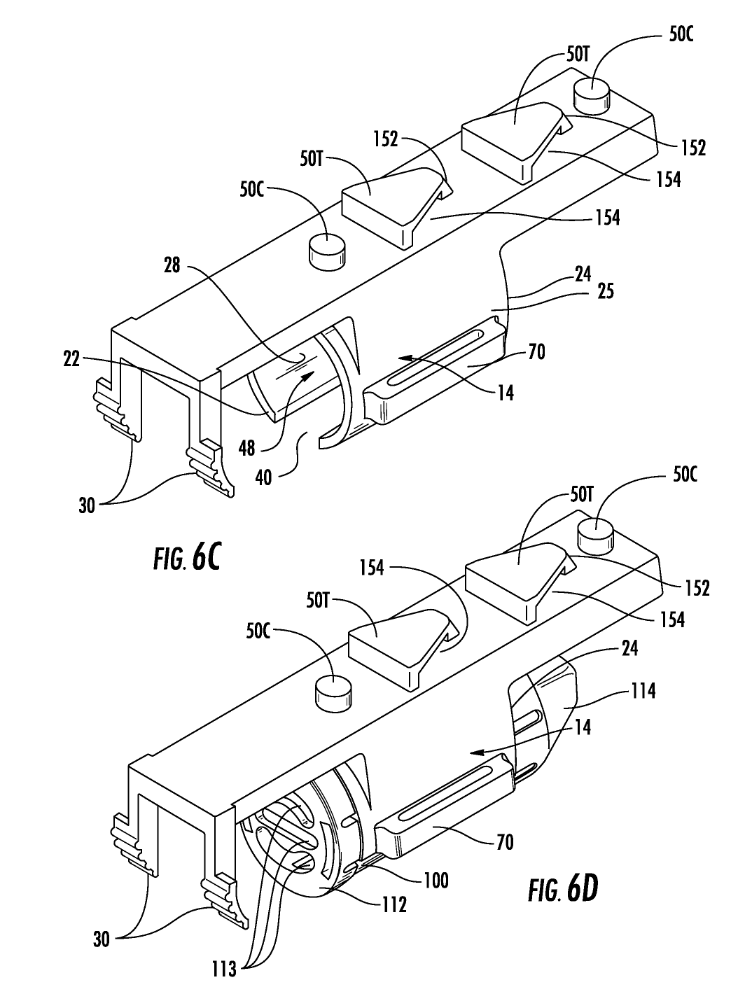

FIG. 6A is a front elevated view of an example embodiment of clip member 10 that includes four mounting features 50. Two of the mounting features 50 have a triangular shape and are denoted 50T. Triangular mounting features 50T include a central support post 152 that defines respective side slots 154. The other two mounting features 50 have a circular shape and are denoted 50C. In an example, only one circular mounting feature 50C can be employed.

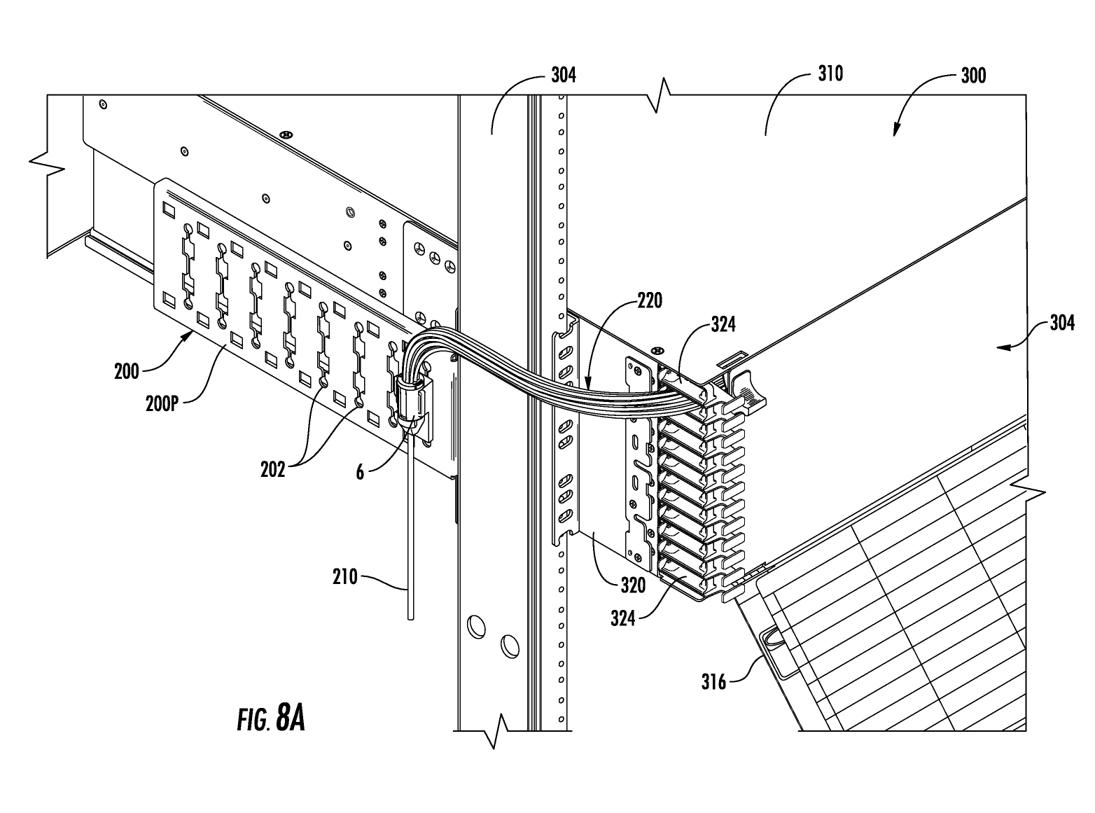

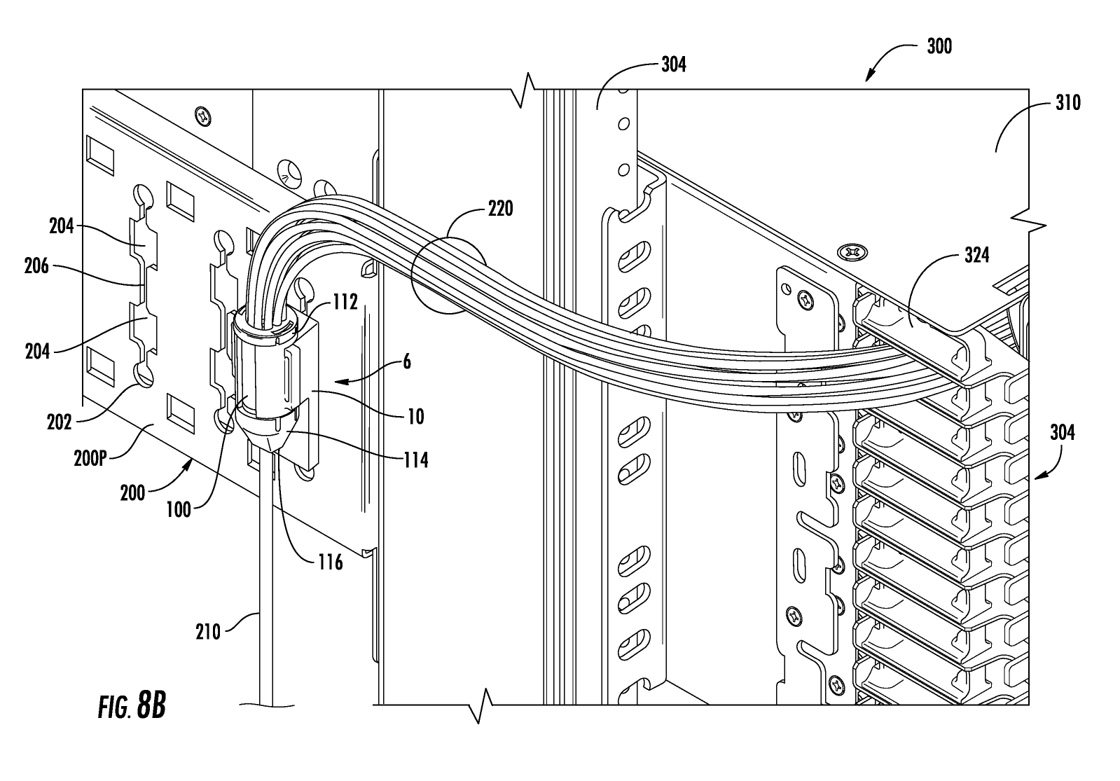

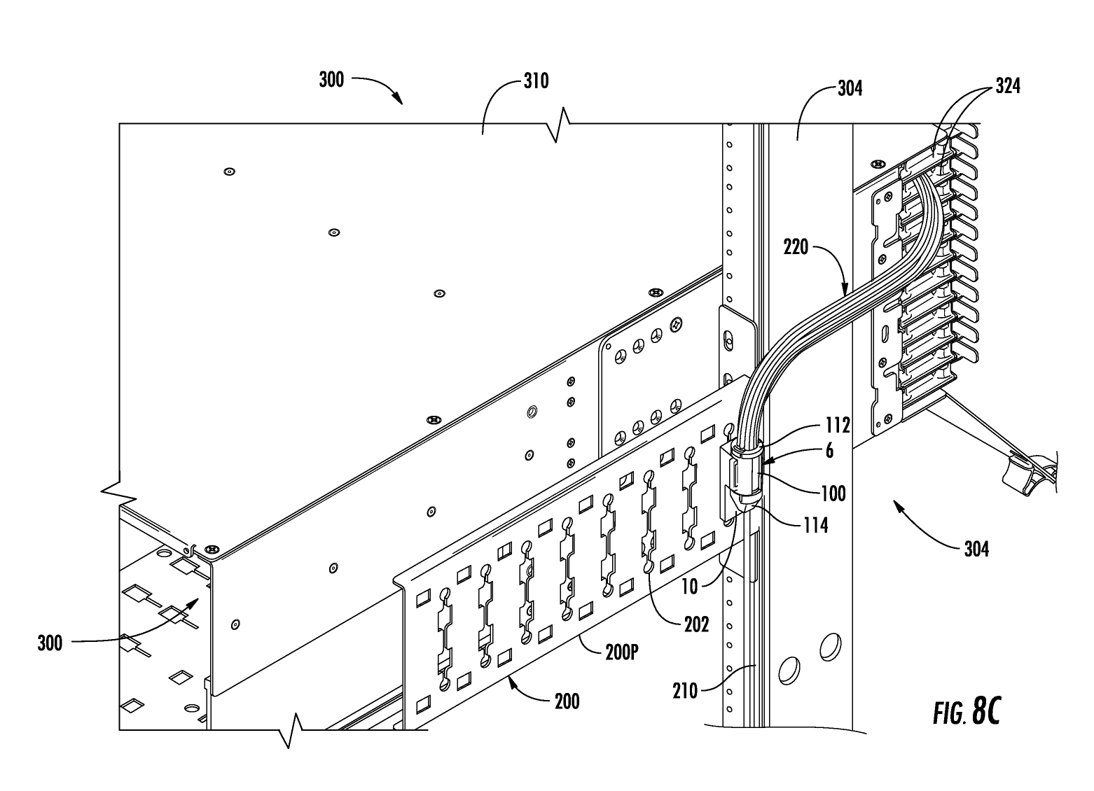

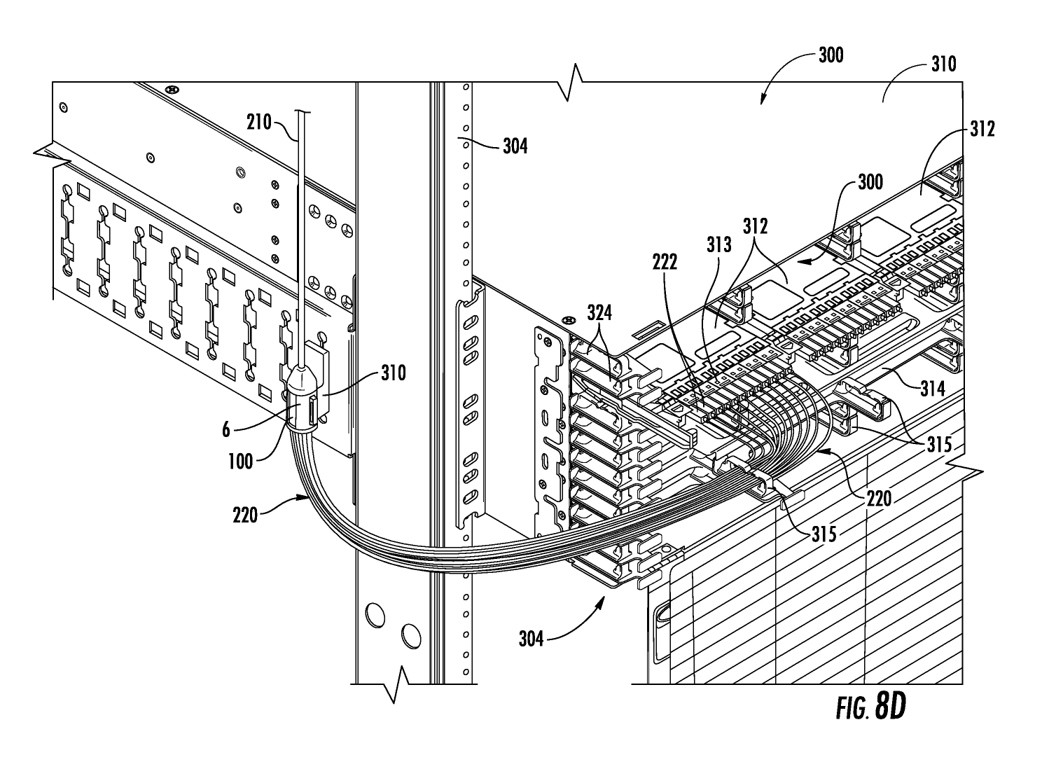

FIG. 6A also shows an example mounting structure 200 in the form of a mounting plate 200P. The mounting plate 200P includes a mounting aperture 202 that includes square openings 204S connected by a narrow slot 206, with circular openings 204C at each end of the mounting aperture. The square openings 204S include respective rear edges 208. Square openings 204S are configured to allow the two triangular mounting features 50T to fit therein while circular openings 204S are sized to accommodate circular mounting features 50C. When clip member 10 is slid in the-Z direction relative to mounting structure 200, slots 154 of triangular mounting features 50T engage rear edges 208 as support post 152 moves into narrow slot 206. Meanwhile, circular mounting features 50C fit into and engage circular openings 204C. This configuration is employed in the example embodiments shown in FIGS. 8A through 8D.

FIG. 6B shows clip member 10 of FIG. 6A operably engaged with furcation plug 100 to form an example furcation assembly 6.

FIGS. 6C and 6D are similar to FIG. 6A and 6B and illustrate an example clip member 10 and furcation assembly 6 that include optional guide arms 30 at the front end of the clip member. Guide arms 30 provide a lever to aid in the removal of clip member 10 from mounting structure 200. Example guide arms 30 are as described in U.S. Patent Application Publication No. US2010/00202740, which is incorporated by reference herein.

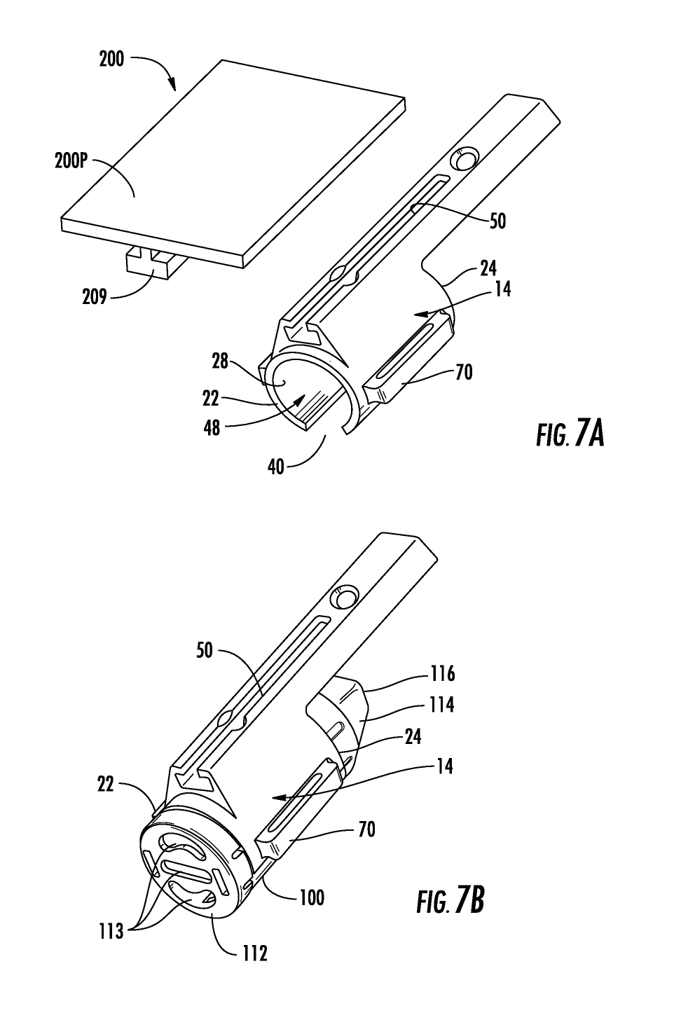

FIG. 7A is similar to FIG. 6A and illustrates an example embodiment of clip member 10 that includes mounting feature 50 in the form of a T-shaped slot. The mounting plate 200P includes a complementary T-shaped mounting member 209 that slidingly engages with T-shaped slot 50 of clip member 10.

FIG. 7B shows clip member 10 of FIG. 7A operably engaged with furcation plug 100 to form an example furcation assembly 6.

FIGS. 8A through 8D are elevated rear-end views of an example of telecommunications apparatus (equipment) 300 that one might find at a data center of a telecommunications network. The telecommunications apparatus 300 includes equipment rack 304 that supports a fiber-optic equipment housing 310, such as an interconnect unit (ICU). The housing 310 is used to operably support one or more telecommunication devices 312 as part of a fiber-optic network. Housing 310 has a rear end 334.

In an example illustrated in FIG. 8D, equipment housing 310 is configured as an ICU configured to support telecommunications devices 312 in the form of fiber-optic modules that provide cable-to-cable fiber-optic connections and that manage the polarity of fiber-optic cable connections. Example fiber-optic modules are disclosed in U.S. Pat. No. 6, 869,227 and in U.S. Patent Application Publication No. 2011/0129186, which are incorporated by reference herein. The housing 310 includes a front door 316 and a side 320, which has a plurality of guide slots 324 that lead into a housing interior 330 near housing rear end 332.

A mounting plate 200 such as that shown in FIG. 6A is shown in FIGS. 8A-8C as attached to rack 304 near housing side 320. The example furcation assembly 6 as shown in FIG. 6B is shown as being operably mounted to mounting plate 200P. The MF cable 210 is shown leading into furcation assembly 6 at strain-relief member 114 at rear end 104. Multiple connecting cables 220 pass through first and second apertures 113 and through one or more of housing guide slots 324. The optical fibers 212 of MF cable 210 are furcated within interior 108 of furcation plug 100 to form connecting cables 220. Example connecting cables 220 are jumper cables used to connect to adapters of fiber-optic modules. Example connecting cables 220 are connectorized with LC connectors and can be single-fiber or duplex.

FIG. 8D is similar to FIG. 8A but shows furcation assembly 6 mounted in the opposite direction on mounting plate 200P. FIG. 8D further shows telecommunications devices operably supported in a drawer 314 within housing interior 330. The connecting cables 220 are shown as being routed through a cable guide 315 on drawer 314. The connecting cables 220 have connectorized ends 222, and the connecting cables fan out from cable guide 315 and are connected at their connectorized ends to corresponding adapters 313 on telecommunications device 312.

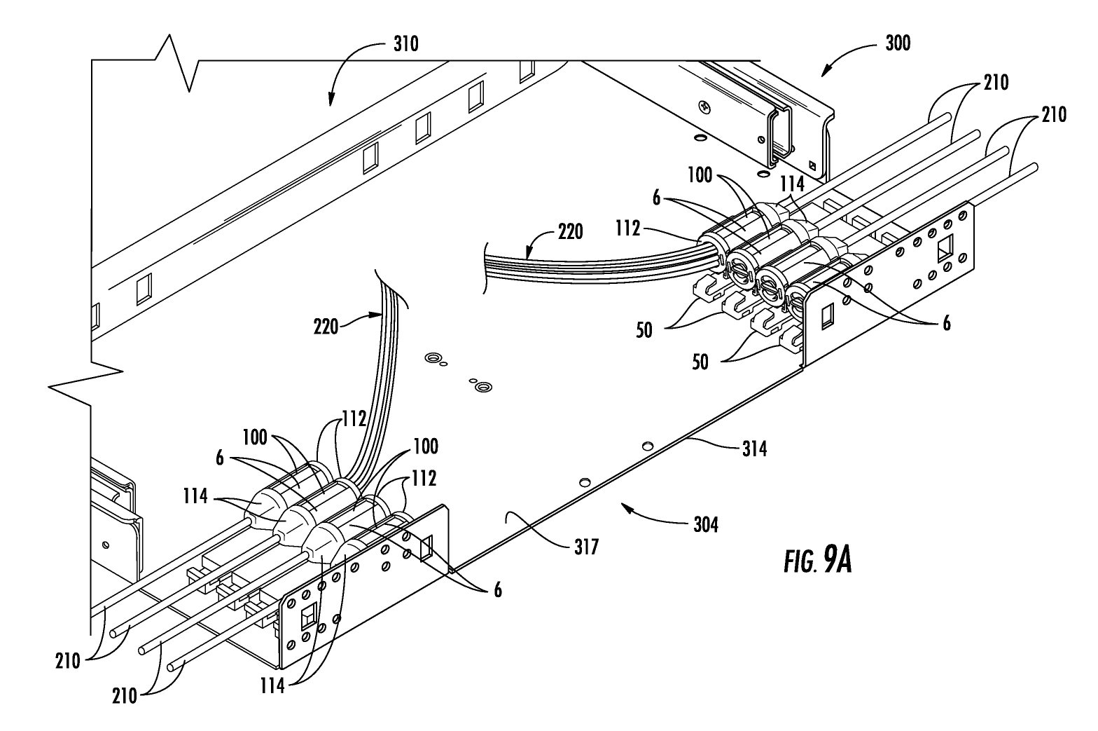

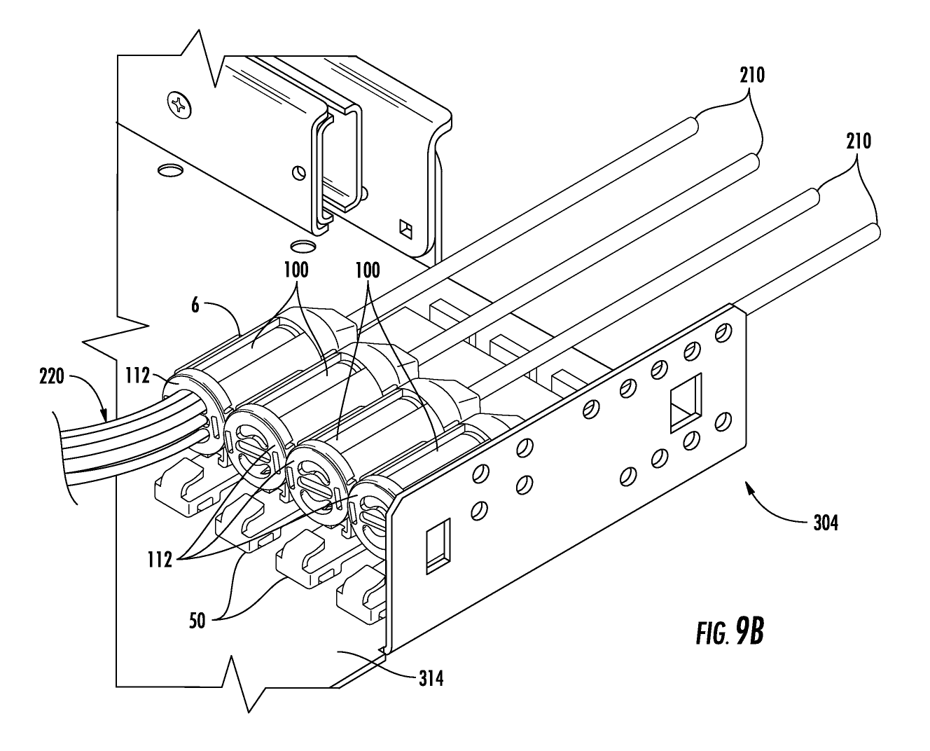

FIG. 9A is an elevated view and FIG. 9B is a close-up elevated view of a first example housing 310 that includes a sliding drawer 314 at housing front end 332. The drawer 314 includes a floor 317 onto which a plurality of furcation assemblies 6 are mounted via mounting features 50 of clip member 10 that attach to the floor. The MF cables 210 enter the respective sides of drawer 314 and connect to respective furcation assemblies 6. For ease of illustration, only two of the furcation assemblies 6 are shown as having connecting cables 220.

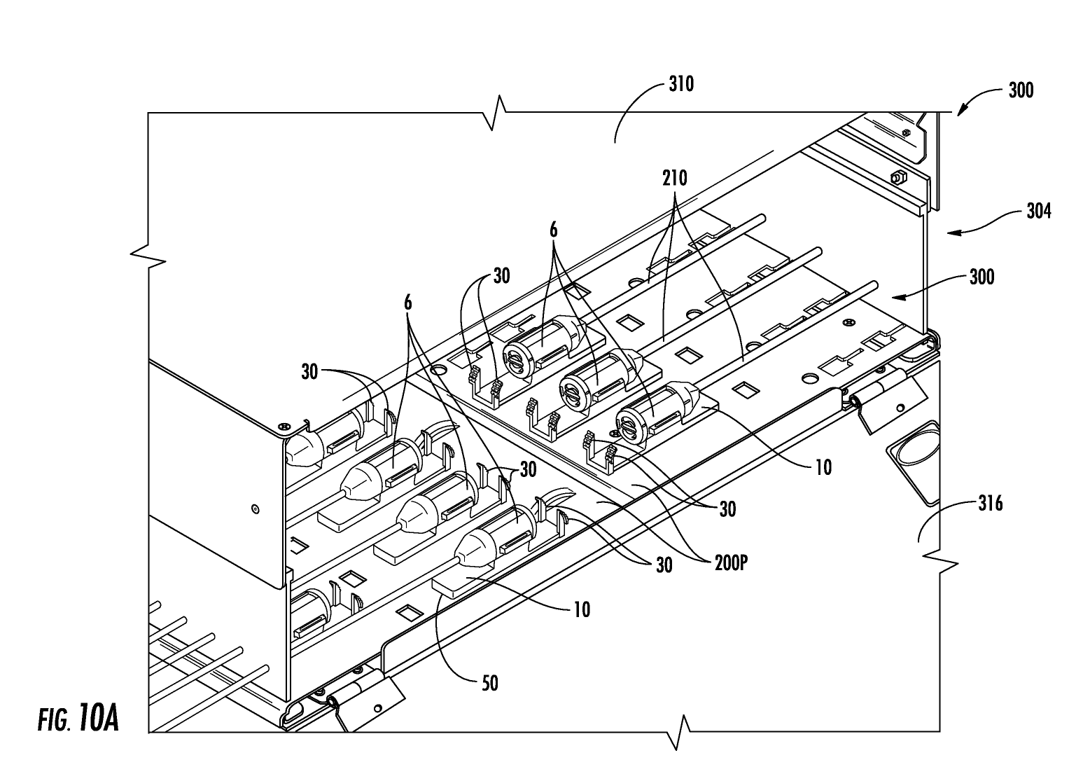

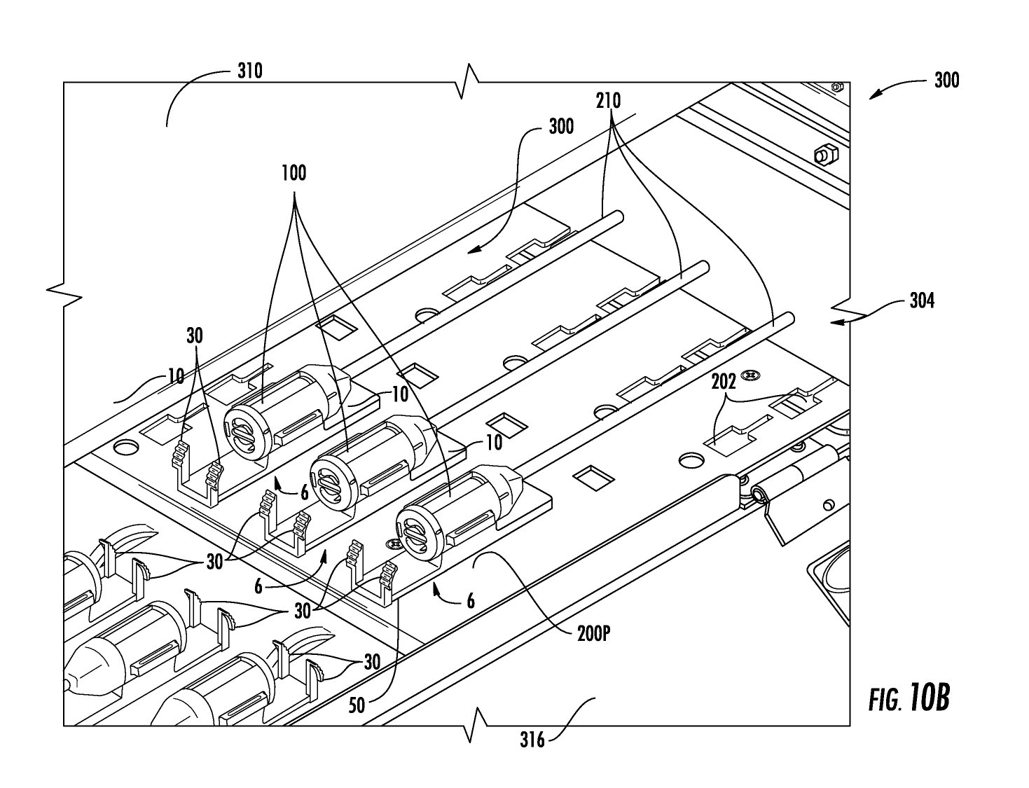

FIG. 10A is an elevated view and FIG. 10B is a close-up elevated view of a second example housing 310 similar that of FIGS. 9A and 9B that show drawer 314 supporting two mounting plates 200P on floor 317. Each mounting plate 200P includes a plurality of furcation assemblies 6 mounted thereto, with the furcation assemblies of the different mounting plates facing one another.

Examples of drawers, housings and equipment racks are disclosed in U.S. Patent Application Publication No. 2010/0296790, which is incorporated by reference herein.

It will be apparent to those skilled in the art that various modifications and variations can be made to the present invention without departing from the spirit and scope of the invention. Thus, it is intended that the present invention cover the modifications and variations of this invention, provided they come within the scope of the appended claims and their equivalents.

What is claimed is:

1. A furcation assembly for furcating optical fibers of a multi-fiber fiber-optic cable (“MF cable”) to form multiple connecting cables, comprising:
a furcation plug having a longitudinal axis and an interior sized to accommodate furcation of the optical fibers; and
a clip member having at least one mounting feature and having a holding feature that holds the furcation plug such that the furcation plug can axially rotate within the holding feature.

2. The furcation assembly of claim 1, wherein the holding feature includes at least one first retaining feature, and wherein the furcation plug includes at least one second retaining feature, and wherein the first and second retaining features operably engage when the furcation plug is engaged by the holding feature.

3. The furcation assembly of claim 1, wherein the at least one first retaining feature consists of front and rear retaining rings, and wherein the at least one second retaining feature consists of front and rear indent rings.

4. The furcation assembly of claim 1, further comprising a mounting structure that includes at least one second mounting feature configured to operably engage with the at least one first mounting feature of the clip member.

5. The furcation assembly of claim 1, wherein the clip member has an outer surface that includes at least one securing feature.

6. The furcation assembly of claim 1, wherein the holding feature comprises a truncated tubular body having a longitudinal opening.

7. A telecommunications apparatus, comprising:
an equipment rack;
a housing supported by the equipment rack and configured to operably support one or more telecommunication devices;
a mounting structure having one or more second mounting features and that is mounted to either the equipment rack or the housing; and
a furcation assembly for furcating optical fibers of a multi-fiber fiber-optic cable (“MF cable”), comprising: a furcation plug having a longitudinal axis and an interior sized to accommodate furcation of the optical fibers; and a clip member having at least one mounting feature and having a holding feature that holds the furcation plug such that the furcation plug can axially rotate within the holding feature, wherein
the furcation assembly is operably mounted to the mounting structure, with the MF cable and connecting cables furcated within the furcation plug interior, and wherein the connecting cables are operably connected to the one or more telecommunication devices.

8. The telecommunications apparatus of claim 7, wherein the holding feature comprises a truncated tubular body having a longitudinal opening.

9. The telecommunications apparatus of claim 8, wherein each connecting cable includes a connectorized end.

10. The telecommunications apparatus of claim 8, wherein each connecting cable includes either a pigtail configured for splicing or a field-installable connector.

11. A furcation assembly for furcating optical fibers from a multi-fiber fiber-optic cable (“MF cable”) to form multiple connecting cables, comprising:
a furcation plug having a first longitudinal axis, an interior sized to accommodate furcation of the optical fibers section, and a front end configured to engage a removable front cover having apertures sized to pass one or more of the connecting cables; and
a clip member having a holding feature with a second longitudinal axis and that is configured such that the furcation plug can be snap-engaged with the holding feature so that the first and second longitudinal axes are substantially coaxial, wherein
the furcation plug can axially rotate within the holding feature, and
the tubular clip member includes at least one mounting feature.

12. The furcation assembly of claim 11, wherein the holding feature includes at least one first retaining feature, and wherein the furcation plug includes at least one second retaining feature that operably engages with the at least one first retaining feature when the furcation plug is held by the holding feature.

13. The furcation assembly of claim 11, wherein the at least one first retaining feature includes front and rear first retaining rings, and the at least one second retaining feature comprises front and rear second retaining rings configured to engage with the front and rear first retaining rings.

14. The furcation assembly of claim 11, further comprising a mounting structure that includes at least one second mounting feature configured to operably engage with the at least one first mounting feature of the clip member to mount the clip member on the mounting structure.

15. The furcation assembly of claim 11, wherein the holding feature comprises a truncated tubular body having a longitudinal opening.

16. A telecommunications apparatus, comprising:
a furcation assembly for furcating optical fibers from a multi-fiber fiber-optic cable (“MF cable”) to form multiple connecting cables, comprising: a furcation plug having a first longitudinal axis, an interior sized to accommodate furcation of the optical fibers section, and a front end configured to engage a removable front cover having apertures sized to pass one or more of the connecting cables; and a clip member having a holding feature with a second longitudinal axis and that is configured such that the furcation plug can be snap-engaged with the holding feature so that the first and second longitudinal axes are substantially coaxial, wherein the furcation plug can axially rotate within the holding feature, and the tubular clip member includes at least one mounting feature;
an equipment rack;
a housing supported by the equipment rack and configured to operably support one or more telecommunication devices; and
a mounting structure having one or more second mounting features and that is mounted to either the equipment rack or the housing, wherein
the clip member of the furcation assembly is mounted to the mounting plate, with an MF cable and connecting cables furcated within the furcation plug interior, and the connecting cables having ends configured to operably connected to the one or more telecommunications devices.

17. The furcation assembly of claim 16, wherein the holding feature comprises a truncated tubular body having a longitudinal opening.

18. A method of furcating optical fibers in a multi-fiber fiber-optic cable (“MF cable”) to form connecting cables, comprising:
furcating the MF cable optical fibers within an interior of a furcation plug having a longitudinal axis; and
holding the furcation plug in a holding feature of a clip member, wherein the furcation plug can axially rotate within the holding feature.

19. The method of claim 18, further comprising:
mounting the clip member to an equipment rack or an equipment housing that operably supports one or more telecommunications devices; and
routing the connecting cables from the furcation plug to the one or more telecommunication devices.

20. The method of claim 18, wherein the holding feature comprises a truncated tubular body having a longitudinal opening.

21. The method of claim 20, wherein the furcation plug has a front end with a removable end cap arranged thereon, and including passing multiple connecting cables through each of one or more apertures in the end cap.

22. The method of claim 20, wherein the connecting cables include either one or two connecting optical fibers, and include respective ends that have either a connector, a pigtail configured for splicing, or a field-installable connector.

23. The method of claim 22, wherein the MF cable defines a trunk cable, a distribution cable, or a harness cable of a telecommunications system or telecommunications network.
